(19) United States
(12) Patent Application Publication
(10) Pub. No.: US 2020/0130954 A1
(43) Pub. Date: Apr. 30, 2020

(54) FEEDING DEVICE AND FEEDING METHOD

(71) Applicant: HOMAG GmbH, Schopfloch (DE)

(72) Inventors: Klaus REICH, Lossburg (DE); Michael HAGEWALD, Altensteig (DE); Martin CALMBACH, Horb-Diessen (DE)

(21) Appl. No.: 16/606,699

(22) PCT Filed: May 14, 2018
(86) PCT No.: PCT/EP2018/062333

§ 371 Date: Oct. 18, 2019

(30) Foreign Application Priority Data
May 16, 2017 (DE) 10 2017 208 212.7

(51) Int. Cl. B65G 47/90

(52) U.S. Cl. CPC B65G 47/90

(57) ABSTRACT

The invention relates to a feeding device for feeding a plate-type workpiece to a machining device, said workpiece preferably being made, at least in sections, of wood, wood-based material, plastic or the like, the feeding device comprising a storage means designed to receive workpieces in a first position and a second position, said two different positions being arranged such that they provide access to the respectively provided workpieces independently of each other. The feeding device also comprises a grip device which is designed to grip a workpiece that has been received in one of the positions in the storage means, and to transport it in relation to the feeding device and independently therefrom such that said workpiece can be machined by the machining device, the gripping device then being a position to be able to transport said workpiece to the other position of the storage means and to place the machined workpiece in this position.

### TECHNICAL FIELD

The present invention relates to a feeding device for feeding a panel-shaped workpiece, which preferably at least in some sections is made of wood, wood-based material, synthetic material or the like, to a machining device, according to the preamble of claim 1. The present invention also relates to a feeding method according to the preamble of claim 9.

### PRIOR ART

A manufacturing system comprising a machining center and a feeding device is known to the applicant from DE 10200502119 B3. According to said disclosure, the machining center is fed by way of a guide device which also enables a machining of the workpiece.

In addition, a method for machining panel-shaped workpieces is known to the applicant from EP 1 645 379 A1, with a machining device and a panel to be machined being moved jointly in said method.

One common feature of the devices and methods in the prior art which provide for automatic feeding of a machining device is that a high degree of automation is achieved, this high degree of automation being achieved by way of complicated and expensive devices. Furthermore, in the case of the feeding devices in the prior art, it is not possible to retrofit existing machining devices therewith.

### SUMMARY OF THE INVENTION

The present invention was therefore based on the technical problem of providing a feeding device for feeding a panel-shaped workpiece, which preferably at least in some sections is made of wood, wood-based material, synthetic material or the like, to a machining device, which feeding device enables automatic feeding of the machining device and also has the ability to be retrofitted on existing machining devices, as well as having low investment costs.

According to the invention, this problem is solved by a feeding device having the features of claim 1 and by the feeding method having the features of claim 9. Preferred embodiments are specified in the dependent claims.

The invention is based on the concept that the inability to retrofit existing machining devices with feeding devices, and also the high complexity thereof, is due mainly to the fact that the feeding device and the machining device are integrally connected to one another in the prior art in order thus to enable short throughput times and a high degree of automation, and in addition, in the case of DE 10200502119 B3, have a common guide device for the feeding device and the machining device.

The present invention utilizes this discovery and provides a feeding device for feeding a panel-shaped workpiece to a machining device which is able to feed the machining device by means of a gripping device.

The present invention provides a feeding device for feeding a panel-shaped workpiece, which preferably at least in some sections is made of wood, wood-based material, synthetic material or the like, to a machining device. In this embodiment, the feeding device comprises a storage means which is designed to receive workpieces at a first position and a second position, with these two different positions being arranged such as to enable access to the respective provided workpieces independently of one another. The feeding device of this embodiment also comprises a gripping device which is designed to grip a workpiece that has been received in one of the positions in the storage means and to transport it relative to and independently of the feeding device such that said workpiece can be machined by the machining device, and which is then able to transport said workpiece to the other of the positions of the storage means and to deposit the machined workpiece at this position. This embodiment enables automatic feeding of the machining device, with various workpieces being provided to the machining device in a flexible manner and then can be received in the storage means for subsequent further machining or warehousing.

Preferably, the gripping device of the feeding device may comprise a suction gripper and a positioning device. In this case, the positioning device is designed to move the suction gripper spatially. The suction gripper can thus pick up the workpiece and then the suction gripper and the workpiece can be moved jointly by the positioning device.

More preferably, the storage means has a hollow shape, with a top side thereof being open. This ensures that the gripping device can access the workpieces stored in the storage means. In this preferred scenario, access can take place by removal from above. This preferred embodiment has the advantage that, although access is easily possible from one defined spatial direction, the workpieces in the storage means are nevertheless protected if, for example, the storage means is removed from the feeding device.

In this preferred scenario, the storage means may also be a storage box. This storage box can thus be stored at the feeding device by the feeding device until the time of machining.

The gripping device of the feeding device may also preferably be designed such that, during a gripping operation, the gripped workpiece is lifted or held in the storage means such that a gap between a lower edge of the workpiece and an upper edge of the border of the storage means is smaller than a thickness of the workpiece. This specific lifting ensures that only a single workpiece is brought from the storage means to the machining device. In particular, it may happen that multiple workpieces are lifted by the gripping device due to adhesion forces between stored panels, or that panels are permeable to air and thus multiple panels are picked up by suction. If multiple workpieces have been lifted by the gripping device, the workpieces that have been picked up in addition to a first workpiece are thus stripped off during a further movement, that is to say during a further lateral movement of the gripping device. Here, this stripping takes place as a result of the additional workpieces being held back by the border of the storage means.

Yet more preferably, in the feeding device, the storage means may be adjustable in size or the storage means may be of two-part design with two individually removable parts. One storage means can thus be used for different workpieces in a flexible manner, or workpieces which have already been machined can be removed separately from workpieces still to be machined.

Another aspect of the present invention is a machining device which comprises a feeding device.

Another aspect of the present invention is a feeding method for a panel-shaped workpiece which preferably at least in some sections is made of wood, wood-based material, synthetic material or the like. This feeding method according to the invention comprises the following steps. The workpiece is picked up out of a storage means, from a first position, by means of a gripping device and is transported from the storage means to a machining device and independently of the machining device. Furthermore, the workpiece is machined on the machining device and is transported from the machining device, independently of the latter, to a second position of the storage means. The workpiece can thus be deposited at the second position of the storage means. This feeding method thus provides an automatic feeding method for a machining device, with different workpieces being provided to the machining device in a flexible manner and then are received in the storage means for subsequent further machining or warehousing. Furthermore, the transporting of the workpiece can take place substantially independently of what is being carried out by the machining device. An uncoupling of these two steps is thus achieved, namely the feeding and the machining. This therefore means that retrofitting of the machining device can be achieved.

Preferably, the first and second position of the storage means may be designed to receive multiple workpieces arranged one on top of the other. This has the technical effect that multiple workpieces can be arranged in a space-saving manner.

More preferably, the feeding method may comprise an operation of lifting the workpiece, with the workpiece being lifted to such a height that a gap between a lower edge of the workpiece and an upper edge of the storage means is smaller than a thickness of the workpiece. This ensures that just one workpiece is picked up in the gripping device.

Furthermore, the step of picking up the workpiece by means of the gripping device may be a sucking of the workpiece by means of the gripping device. This leads to a quick pick-up and ensures that just one workpiece at a time is picked up.

The feeding method may also be automated in that, based on data acquired by sensors and data stored on a storage medium, the method is able to carry out both the picking-up and transporting steps automatically. Examples of data acquired by sensors are, for example, position data of the gripping device with or without a picked-up workpiece, the weight of the picked-up workpiece. Examples of stored data are, for example, control software, setpoint values for a weight of the workpiece to be picked up.

### BRIEF DESCRIPTION OF THE DRAWINGS

FIG. 1 is a schematic diagram of one preferred embodiment of the device according to the invention, in front view.

FIG. 2 is a schematic diagram of one preferred embodiment of the device according to the invention, in a top view or plan view.

### DETAILED DESCRIPTION OF PREFERRED EMBODIMENTS

Preferred embodiments of the present invention will be described below with reference to the accompanying drawings.

The preferred embodiment relates to a feeding device 13 for feeding panel-shaped workpieces to a machining device. These workpieces are preferably at least in some sections made of wood, wood-based material, synthetic material or the like. Such workpieces are used for example in the furniture and construction element industry. It may be a solid wood panel or chipboard panel, a lightweight panel, a sandwich panel or the like. The present invention is not limited to such workpieces.

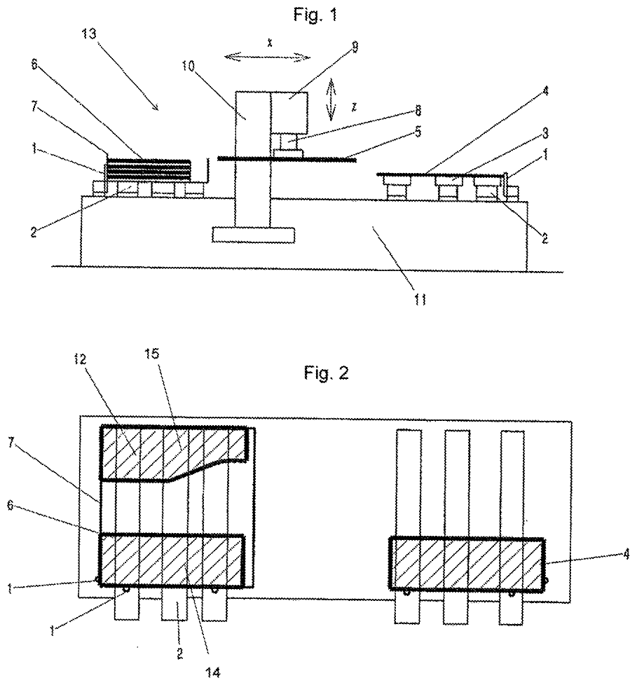

The feeding device 13 of this preferred embodiment will be described in detail below with reference to FIGS. 1 and 2.

The feeding device 13 comprises one storage means 7. Alternatively, the feeding device 13 may comprise two or more storage means 7. In this preferred embodiment, said storage means 7 is arranged on a machine bed 11 of a machining device (not shown in greater detail). This illustrates in particular that different machining device can be equipped with the feeding device 13 according to the invention.

The storage means 7 serves as a workpiece store (a) for workpiece blanks 6 and (b) for finished machined workpieces 12. In this context, finished machined workpieces 12 does not mean that substantially no further machining steps are to be carried out, but rather that no further machining steps are necessary on the machining device that is being fed by the feeding device according to the invention. Conversely, workpiece blank 6 does not mean that these have not yet undergone any machining, but rather that no machining has been carried out on the machining device that is being fed by the feeding device according to the invention. Workpiece blanks can be stored in the storage means 7 at a first position 14, and finished machined workpieces 12 can be stored in the storage means 7 at a second position 15. These different positions enable independent access thereto, that is to say that both of these stored types of workpieces can be accessed independently of one another. For better alignment of the storage means 7, stops 1 are also provided on the machine bed 11. This enables a straightforward alignment against said stops. A user can thus move the storage means 7 until the latter butts against the stop 1. This saves working time and increases the positioning accuracy. In addition, a number of supports 2 are provided between the machine bed 11 and the storage means 7. These supports thus receive the storage means 7 and may be height-adjustable. In this illustrated embodiment of the feeding device according to the invention, the storage means 7 is designed as a storage box having at least one side wall. The precise design of this storage box, which may for example be a crate, can be selected at will. In order to minimize costs, use may be made for example of a standard size which is large enough to accommodate workpieces at different positions and deep enough to accommodate a suitable number of workpieces. It may also be advantageous to select the combination of support 2 and storage means 7 such as to enable the storage means 7 to be lifted by means of a suitable transport device, such as a forklift truck for example.

The storage means 7 can be removed for any desired batch size. This depends in particular on the size of the workpiece blanks 6 used or of the finished machined workpieces 12 and on a total number of the of workpieces to be machined. The storage means is in particular also able to be removed for a batch size 1.

A height of the side wall of the storage means 7 may be selected such that an operation of lifting a workpiece blank 6 at the first position 13 leads to the gap between a lower edge of the lifted workpiece and the upper edge of the storage means 7 being smaller than a thickness of the workpiece. It can thus effectively be ensured, without using any additional means, that in each case only one workpiece is moved onward and then machined. In the case where multiple workpiece blanks 6 are lifted by the gripping device 10 as a result of adhesion forces between stored workpiece blanks 6 or in the case where workpiece blanks 6 are permeable to air and thus multiple workpiece blanks 6 are picked up by suction. If multiple workpiece blanks 6 have been lifted by the gripping device 10, the workpiece blanks 6 that have been picked up in addition to a first workpiece blank 6 are thus stripped off during a further movement, that is to say during a further lateral movement of the gripping device 10. Here, this stripping takes place as a result of the additional workpiece blanks 6 being held back by the border of the storage means 7.

It is also possible to design the storage means 7 in two parts, with the first position 14 and the second position 15 being distributed. The workpiece blanks 6 and the finished machined workpieces 12 can thus, independently of one another, be brought to respective storage positions.

The feeding device further comprises a gripping device 10. This gripping device has the task of moving workpieces between the storage means 7 and a machining device (not shown). In this described embodiment, the gripping device 10 comprises a suction gripper 8 which can grip workpieces by suction and then move them. The sucking operation thus provides an operation that establishes a connection between the suction gripper 8 and the workpiece. The gripping device 10 additionally comprises a positioning device 9. This positioning device 9 produces a relative movement between the storage means 7 and the suction gripper 8. Since the workpiece can in turn be sucked onto the suction gripper 8, a relative movement between the storage means 7 and the workpiece is thus produced, and a feeding of the machining device is enabled.

On the suction gripper 8, it is possible to see one workpiece 5 which is in this way picked up and moved.

In this embodiment, the positioning device 9 provides for changing the position of the suction gripper 8 in three independent spatial directions. The orthogonal axes Z and X are shown in FIG. 1, with the Z-axis being in this case a direction along the direction of gravity. The suction gripper can thus first lift a workpiece in the Z-axis, in order then to initiate a movement on the X-Y plane so as to move the workpiece as required.

Furthermore, in the embodiment shown here, no rotation about the X, Y, and Z axes is possible. This means that the workpieces maintain their orientation relative to the storage means 7. However, other embodiments according to the invention are conceivable, in which such a rotation of the workpieces takes place, for example in order to better utilize the space available in the storage means 7 or in order to enable a more individual machining on the machining device.

The above-described possible movements of the gripping device, in particular of the positioning device, and the sucking operations of the suction gripper 8 can be carried out in an automated manner in this embodiment. This means that a control unit controls these movements and sucking operations and can carry these out in a substantially automated manner. It is also possible that the necessary control data are provided locally on a storage medium or are provided by a network connection of the control unit.

In this embodiment, therefore, the feeding device 13 enables a method for automatic feeding of a panel-shaped workpiece which preferably at least in some regions is made of wood, wood-based material, synthetic material or the like.

This method comprises the step that a workpiece blank 6 is picked up by the gripping device 10.

This picking-up operation may begin with the suction gripper 8, without any workpiece picked up thereon, being positioned directly above such a workpiece blank 6. In the case where multiple workpiece blanks are arranged one on top of the other, the workpiece blank 6 that is to be picked up is the uppermost of these workpiece blanks. In this embodiment, the positioning takes place in the X-Y plane. The suction gripper 8 has a sufficiently large overlap with the workpiece blank 6 that the latter can be picked up. The suction gripper 8 is then lowered over the workpiece blank 6 in the Z-axis. This takes place until a connection is established between the suction gripper 8 the workpiece blank 6. This lowering step can either be monitored by sensors, in particular distance sensors, in real time, or can be stopped manually or in a predefined manner. As soon as contact is established between the workpiece blank 6 and the suction gripper 8, the suction gripper 8 preferably starts to suck the workpiece blank 6. This sucking may be implemented such that air is extracted from suction cups so as thus to produce a negative pressure or almost a vacuum. A force-fitting connection between the suction gripper 8 and the workpiece blank 6 is thus established.

As soon as this picking-up operation has been carried out, the suction gripper 8 and the workpiece blank 6 can then be transported jointly. FIG. 1 shows such a transport state with the workpiece 5. First, the workpiece 5 together with the suction gripper 8 is lifted, i.e. is moved in the Z direction. The lifting may take place until the gap between an upper edge of the storage means 7 and the lower edge of the workpiece that has been picked up is smaller than the thickness of the workpiece. This ensures that just one single workpiece remains on the suction gripper 8 during a subsequent movement away from the storage means 7. Particularly in the case where multiple workpieces are lifted by the gripping device 10 as a result of adhesion forces between stored workpieces or as a result of workpieces 5 being permeable to air and thus multiple workpieces being picked up by suction. If multiple workpieces have been lifted by the gripping device 10, the workpieces that have been picked up in addition to a first workpiece 5 are thus stripped off during a further movement, i.e. during a further lateral movement of the gripping device 10. Here, this stripping takes place as a result of the additional workpieces being held back by the border of the storage means 7.

After being lifted, the workpiece can then be moved in the X-Y plane, as shown in FIG. 1, toward a machining space of the machining device (right-hand area in FIG. 1 and FIG. 2). The workpiece is then lowered onto this machining space and is secured by way of a securing device 3, which may for example be a suction element.

The transport steps described above for transporting the workpiece have been presented as taking place individually one after the other. Of course, in order to increase efficiency, some of these steps may also be combined, for example by simultaneously moving in the Z direction and in the X-Y plane.

After this transport operation, the workpiece 4 is then securely connected to the securing device 3 by the latter. The machining step then takes place by means of a machining device (not shown). This machining may relate to the edges of the workpiece; portions may be cut off from the workpiece, as can be seen in the comparison of the non-machined workpiece 6 and the finished machined workpiece 12 in FIG. 2. Also conceivable, however, are a wide range of other machining methods, for example welding, drilling or milling. During this machining operation, the workpiece 4 remains securely connected to the securing device 3 in order to prevent slippage.

The finished machined workpiece is then picked up again by the suction gripper 8 and is transported back to the storage means 7. This takes place substantially in the same way as the transport operation described above, but in reverse order. However, the end point of this transporting is a second position in the storage means, at which the finished machined workpiece 12 is now received.

Once this transporting of the machined workpiece 12 is complete, the suction gripper can then be placed for example in a tool changer (TC) of the machining device and thus stored. This may be particularly advantageous if the machining in the machining device takes a relatively long time or if the machining device is not in operation during rest periods, in order thus to protect the suction gripper used.

1. Feeding device for feeding a panel-shaped workpiece, which at least in some sections is made of wood, wood-based material, synthetic material or the like, to a machining device, wherein the feeding device comprises:
a storage means which is designed to receive workpieces at a first position and at least a second position, wherein these two different positions are arranged such as to enable access to the respective provided workpieces independently of one another; and
a gripping device which is designed to grip a workpiece that has been received in one of the positions in the storage means and to transport it relative to the storage means such that said workpiece can be machined by the machining device, and which is then able to transport said workpiece to the other of the positions of the storage means and to deposit the machined workpiece at the other position.

2. Feeding device according to claim 1,
wherein the gripping device comprises a suction gripper and a positioning device, wherein the positioning device is designed to move the suction gripper spatially in order-thus to enable transporting of the workpiece.

3. Feeding device according to one of claim 2,
wherein the storage means has a border on at least one side thereof so as to ensure that the gripping device can access workpieces stored therein.

4. Feeding device according to claim 3,
wherein the storage means is a storage box.

5. Feeding device according to one of claim 3, wherein the gripping device is designed to lift the gripped workpiece in the storage means, after a gripping operation, such that a gap between a lower edge of the workpiece and an upper edge of the storage means is smaller than a thickness of the workpiece.

6. Feeding device according to one of claim 1, wherein the feeding device comprises a control unit for automatically controlling the feeding device.

7. Feeding device according to one of claim 1, wherein the storage means is adjustable in size or the storage means is of two-part design with two individually removable parts.

8. Machining device which comprises a feeding device according to one of claim 1.

9. Feeding method for a panel-shaped workpiece which at least in some sections is made of wood, wood-based material, synthetic material or the like, wherein the feeding method comprises the following steps:
picking up the workpiece out of a storage means, from a first position, by means of a gripping device; and
transporting the workpiece from the storage means to a machining device, independently of the latter.

10. Feeding method according to claim 9, which comprises the following additional steps:
transporting the workpiece from the machining device, independently of the latter, to a second position of the storage means;
depositing the workpiece at the second position of the storage means.

11. Feeding method according to claim 9,
wherein the first position and the second position of the storage means are designed to receive multiple workpieces arranged one on top of the other.

12. Feeding method according to one of claim 9, wherein the step of moving the workpiece first comprises an operation of lifting the workpiece, wherein the workpiece is lifted to such a height that a gap between a lower edge of the workpiece and an upper edge of the storage means is smaller than a thickness of the workpiece.

13. Feeding method according to one of claim 9, wherein the step of picking up the workpiece by means of the gripping device is a sucking of the workpiece by means of a suction gripper of the gripping device.

14. Feeding method according to one of claim 9, wherein, based on data acquired by sensors and/or data stored on a storage medium, the method is able to carry out both the picking-up and transporting steps automatically.
